(19) United States
(12) Patent Application Publication
(10) Pub. No.: US 2023/0185316 A1
(43) Pub. Date: Jun. 15, 2023

(54) POSITIONING AND NAVIGATION METHOD FOR AUTOMATIC INSPECTION OF UNMANNED AERIAL VEHICLE IN WATER DIVERSION PIPELINE OF HYDROPOWER STATION

(71) Applicant: Tongji University, Shanghai (CN)

(72) Inventor: Runjie Shen, Shanghai (CN)

(73) Assignee: Tongji University, Shanghai (CN)

(21) Appl. No.: 18/104,801

(22) Filed: Feb. 2, 2023

(30) Foreign Application Priority Data
Aug. 15, 2022 (CN) 202210975309.7

(51) Int. Cl. G05D 1/08; G05D 1/10; G06T 7/00; G06T 7/77; G06V 10/762; G01S 17/89; B64C 39/02; G06F 17/17

(52) U.S. Cl. CPC G05D 1/0808; G05D 1/101; G06T 7/0004; G06T 7/77; G06V 10/763; G01S 17/89; B64C 39/024; G06F 17/17; G06T 2207/10028; G06T 2207/10032; B64U 2101/26

(57) ABSTRACT

The present invention discloses a positioning and navigation method for automatic inspection of an unmanned aerial vehicle in a water diversion pipeline of a hydropower station, comprising: using a laser radar carried by an unmanned aerial vehicle (UAV) to scan the inside of a water diversion pipeline to obtain point cloud data; determining the central axis of the cylinder model; determining the foot point of the current position coordinate of the UAV in the central axis in a body coordinate system; calculating the actual speed of the UAV in a central axis coordinate system according to the distance change of central axes of two frames; and adjusting the attitude of the UAV according to the actual speed and the desired speed of the UAV. The present invention can adapt to pipeline environments with different bending degrees.

### TECHNICAL FIELD

The present invention relates to the technical field of inspection and maintenance of water diversion pipelines, and particularly relates to a positioning and navigation method for automatic inspection of an unmanned aerial vehicle in a water diversion pipeline of a hydropower station.

### BACKGROUND

A water diversion pipeline is made of pressure steel pipes by welding and used to deliver water from a reservoir to a turbine to generate electricity. During operation, the water diversion pipeline will be filled with water, and as time goes on, the internal condition of the water diversion pipeline becomes unknown, so it is necessary to regularly check welding seams of the pressure steel pipes of the water diversion pipeline for cracks, peeling, or signs of deterioration such as cavitation and to check the pressure steel pipes for damage protection treatment and signs of corrosion of metals, so as to prevent cracking of the water diversion pipeline that may lead to a disastrous consequence of complete removal of the hydropower station dam.

A conventional inspection method for a water diversion pipeline is manual inspection with lifting ropes, which needs to build a lot of scaffolds or lifting ropes and thus is very dangerous. It is difficult to carry out comprehensive inspection of the pipeline manually, and the conventional inspection method has long cycle and high cost, and is difficult to accurately judge faults.

The GRASP Laboratory in Pennsylvania proposes a three-dimensional laser radar-based pose estimation algorithm, which adopts a Velodyne VLP-16 laser radar, an IMU and four cameras to reconstruct a local map centered on an unmanned aerial vehicle (UAV) through the optimization process in nonlinear manifolds, and optimizes the final six-degree-of-freedom state estimation by an unscented Kalman filter. The proposed method can adapt to pipeline environments with different diameters, cross sections and bending degrees. However, the axis direction of a pipeline is still dependent on vision, visual identification and positioning effects are poor, and a large number of two-dimensional codes are needed.

C. H. Tana et al. from Singapore University of Technology and Design conducts relevant researches on shaft inspection by a UAV, which measures the surrounding distance by carrying a rotating TOF Range sensor, fits two parallel lines on both sides of a water channel or positions the fitting circle of the shaft on a two-dimensional plane. However, this method can only be applied in shafts, is no longer applicable to the inclined and curved section of a water diversion pipeline, and cannot realize estimation along the axis direction, and the whole inspection process needs manual operation by experienced personnel.

Therefore, the problem to be urgently solved by those skilled in the art is how to provide a positioning and navigation method for automatic inspection of an unmanned aerial vehicle in a water diversion pipeline of a hydropower station, which can adapt to pipeline environments with different bending degrees and accurately position a UAV.

### SUMMARY

In view of this, the present invention provides a positioning and navigation method for automatic inspection of an unmanned aerial vehicle in a water diversion pipeline of a hydropower station, which can adapt to pipeline environments with different bending degrees and accurately position and navigate an unmanned aerial vehicle.

To achieve the above purpose, the present invention adopts the following technical solution:

A positioning and navigation method for automatic inspection of an unmanned aerial vehicle in a water diversion pipeline of a hydropower station, comprising:

Using a laser radar carried by an unmanned aerial vehicle (UAV) to scan the inside of a water diversion pipeline to obtain point cloud data, and fitting the point cloud data into a cylinder model;

Determining the central axis of the cylinder model;

Determining the foot point of the current position coordinate of the UAV in the central axis in a body coordinate system, and calculating the target point position of the UAV according to the foot point;

Calculating the actual speed of the UAV in a central axis coordinate system according to the distance change of central axes of two frames, and converting the actual speed of the UAV in the central axis coordinate system to be in a world coordinate system;

Adjusting the attitude of the UAV according to the actual speed and the desired speed of the UAV.

Further, the above positioning and navigation method for automatic inspection of an unmanned aerial vehicle in a water diversion pipeline of a hydropower station further comprises: preprocessing the point cloud data, wherein the step of preprocessing comprises:

Determining the center point of the point cloud data, and capturing point cloud data with the distance from each point to the center point more than 1 m and less than 10 m from the point cloud data;

Calculating the average distance and standard deviation from each point to the nearest K points in the captured point cloud data by a statistical filtering method, and eliminating a noise point cloud according to the standard deviation criterion.

Further, in the above positioning and navigation method for automatic inspection of an unmanned aerial vehicle in a water diversion pipeline of a hydropower station, the step of determining the central axis of the cylinder model comprises:

Equidistantly cutting the cylinder model of the current frame along the X-axis direction of the world coordinate system to obtain a plurality of cut planes; and the layout direction of the water diversion pipeline coincides with the X-axis of the world coordinate system;

Fitting a point cloud on each cut plane into an ellipse model based on the RANSAC algorithm;

Fitting an ellipse center point cluster under the current frame into a straight or curved line to be used as the central axis of the cylinder model of the current frame.

Further, in the above positioning and navigation method for automatic inspection of an unmanned aerial vehicle in a water diversion pipeline of a hydropower station, when the center line of the cylinder model of the previous frame is a straight line, the cut point is:

$$\{ \begin{matrix}\begin{matrix}{x}_{i} = {x}_{min} + i \times step \\ {y}_{i} = \frac{{b}^{′} ( {x}_{i} - {x}_{0} )}{{a}^{′}} + {y}_{0}^{′}\end{matrix} \\ {z}_{i} = \frac{{c}^{′} ( {x}_{i} - {x}_{0} )}{{a}^{′}} + {z}_{0}^{′}\end{matrix}$$

Drawing a plane through the cut point and perpendicular to the center line of the previous frame to obtain a cut plane, and the expression of the cut plane is:

a′(x−xᵢ)+b′(y−yᵢ)+c′(z−zᵢ)=0

Wherein (xi, yi, zi) represents a point on the cut plane, which is also a point in the central axis of the cylinder model;

$$step = \frac{{x}_{max} - {x}_{min}}{52}$$

represents the spacing of cut planes, xₘₐₓ represents the maximum value in the x direction in a three-dimensional coordinate set of point clouds, and xₘᵢₙ represents the minimum value in the x direction in the three-dimensional coordinate set of point clouds; i represents the number of the cut planes of the current frame; x₀ represents the X direction coordinate of a point which the center line of the cylinder model of the previous frame passes; y′₀ represents the Y-direction coordinate of a point which the center line of the cylinder model of the current frame passes; z′₀ represents the Z-direction coordinate of a point which the center line of the cylinder model of the current frame passes; a′ represents the X direction of the direction vector of the center line of the cylinder model of the current frame; b′ represents the Y-direction of the direction vector of the center line of the cylinder model of the current frame; and c′ represents the Z-direction of the direction vector of the center line of the cylinder model of the current frame.

Further, in the above positioning and navigation method for automatic inspection of an unmanned aerial vehicle in a water diversion pipeline of a hydropower station, when the center line of the cylinder model of the previous frame is a curved line, the cut point is:

$$\{ \begin{matrix}{x}_{i} = {x}_{min} + i \times step \\ {y}_{i} = 0 \\ {z}_{i} = {w}_{0}^{′} + {w}_{1}^{′} {x}_{i} + {w}_{2}^{′} {x}_{i}^{2} + {w}_{3}^{′} {x}_{i}^{3}\end{matrix}$$

Drawing a tangent line through the cut point, and the expression of the tangent line is:

$$\{ \begin{matrix}y = 0 \\ z = ( {w}_{1} + 2 {w}_{2} {x}_{i c} + 3 {w}_{3} {x}_{ic}^{2} ) ( x - {x}_{ic} ) + {z}_{ic}\end{matrix}$$

Drawing a plane through the cut point and perpendicular to the tangent line to obtain a cut plane, and the expression of the cut plane is:

x−x_{ic}+(w₁+2w₂x_{ic}+3w₃x_{ic}²)(z−z_{ic})=0

Wherein w′₀ represents the constant term of the curvilinear polynomial of the center line of the cylinder model of the previous frame, w′₁ represents the primary term of the curvilinear polynomial of the center line of the cylinder model of the previous frame, w′₂ represents the quadratic term of the curvilinear polynomial of the center line of the cylinder model of the previous frame, and the w′₃ represents the cubic term of the curvilinear polynomial of the center line of the cylinder model of the previous frame; w₁ represents the primary term of the curvilinear polynomial of the center line of the cylinder model of the current frame, w₂ represents the quadratic term of the curvilinear polynomial of the center line of the cylinder model of the current frame, and the w₃ represents the cubic term of the curvilinear polynomial of the center line of the cylinder model of the current frame; x_{ic} represents the X direction coordinate of a point which the i^{th} cut plane passes; and z_{ic} represents the Z-direction coordinate of a point which the i^{th} cut plane passes.

Further, in the above positioning and navigation method for automatic inspection of an unmanned aerial vehicle in a water diversion pipeline of a hydropower station, the step of fitting a point cloud on each cut plane into an ellipse model based on the RANSAC algorithm comprises:

Respectively fitting the point cloud on each cut plane under the current frame into an ellipse model by the nonlinear least square method and the RANSAC algorithm;

Calculating the center point and the minor semi-axis of each ellipse model;

Averaging the minor semi-axes of all the ellipse models, and taking the obtained average value as the radius of the cylinder model of the current frame.

Further, in the above positioning and navigation method for automatic inspection of an unmanned aerial vehicle in a water diversion pipeline of a hydropower station, the step of fitting an ellipse center point cluster under the current frame into a straight or curved line comprises:

If the central axis of the cylinder model of the previous frame is a straight line, fitting each ellipse center point into a linear model by the RANSAC algorithm, and if the number of interior points that fit the linear model is more than a half, considering the central axis of the current frame as a straight line, or fitting the ellipse center point cluster into a curved line;

If the central axis of the cylinder model of the previous frame is a curved line, fitting all the ellipse center points under the current frame into a curved line; and when coefficients of the second order and above of the polynomial describing the curved line are less than 0.01, refitting the ellipse center point cluster into a straight line.

Further, in the above positioning and navigation method for automatic inspection of an unmanned aerial vehicle in a water diversion pipeline of a hydropower station, the fitting process of the ellipse model is:

\textcircled{1}. Randomly selecting sample points from the ellipse center points, wherein the number of the sample points is more than 4;

\textcircled{2}. Calculating the parameter of each cut plane under the current frame for the selected sample points by the least square model fitting method;

\textcircled{3}. Calculating fitting residuals between all the sample points and the parameters of the cut planes obtained in \textcircled{2};

\textcircled{4}. If the number of the samples recorded in \textcircled{3} is more than the threshold of the number of the interior points, stopping searching for interior points and saving the sample data;

\textcircled{5}. Repeating \textcircled{2} to \textcircled{4} for N times, and if the number of the interior points is less than the threshold of the number of the interior points, stopping searching for interior points, and saving the maximum number of interior points in the interior point set and sample data;

\textcircled{6}. Solving the parameter of the ellipse model for the sample data saved in \textcircled{4} or \textcircled{5} by least square fitting, and the obtained parameter is the optimum parameter for fitting of the ellipse model.

Further, in the above positioning and navigation method for automatic inspection of an unmanned aerial vehicle in a water diversion pipeline of a hydropower station, the desired speed of the UAV is determined according to the current position and the target position of the UAV; and the coordinate of the foot point of the current position coordinate of the UAV in the central axis in the body coordinate system is D(x_{d}, y_{d}, z_{d})=(xᵢ+uᵢaᵢ, yᵢ+uᵢbᵢ, zᵢ+uᵢcᵢ);

The coordinate of the target point position is T (xₜ, yₜ, zₜ)=(x_{d}+kaᵢ, y_{d}+kbᵢ, z_{d}+kcᵢ);

Wherein (aᵢ, bᵢ, cᵢ) is the X-axis direction vector in the central axis coordinate system.

Further, in the above positioning and navigation method for automatic inspection of an unmanned aerial vehicle in a water diversion pipeline of a hydropower station, the calculation process of the actual speed of the UAV in the world coordinate system is:

Obtaining the expression of the Z-axis direction vector in the central axis coordinate system in the body coordinate system according to the cross product of the X-axis direction vector and the Y-axis direction vector in the central axis coordinate system:

Z(z1,z2,z3)=(aᵢ,bᵢ,cᵢ)×(sin γᵢ,cos γᵢ,0)=(−cᵢ cos γᵢ,cᵢ sin γᵢ,aᵢ cos γᵢ−bᵢ sin γᵢ)

Wherein γᵢ represents an included angle between the plane of the straight or curved line fitted from the ellipse center point cluster of the i^{th} frame and the XOZ plane of the body coordinate system; and (sin γᵢ, cos γᵢ, 0) represents the Y-axis direction vector in the central axis coordinate system;

Projecting the distance from the current position of the UAV to the foot point to the Z-axis direction in the central axis coordinate system;

Dis_{z}=(xᵢ+uᵢaᵢ,yᵢ+uᵢbᵢ,zᵢ+uᵢcᵢ)·(z1,z2,z3)

Calculating the speed V_{cz} of the UAV in the Z-axis direction in the central axis coordinate system according to the distance change of two frames;

Calculating the speed V_{wz} of the UAV in the Z-axis direction in the world coordinate system by combination of a barometer and an accelerometer;

Converting the speed in the central axis coordinate system to be in the world coordinate system according to the rotation relationship of the coordinate systems; and the calculation formula of the speed of the UAV in the X-axis direction in the world coordinate system is:

$${V}_{w x} = \frac{( {V}_{w z} - {V}_{c z} cos δ )}{sin δcosδ} - {V}_{c z} sin δ$$

Wherein δᵢ=sec cᵢ represents an included angle between the central axis of the i^{th} frame and the XOY plane in the body coordinate system.

It can be known from the above technical solution that compared with the prior art, the present invention discloses a positioning and navigation method for automatic inspection of an unmanned aerial vehicle in a water diversion pipeline of a hydropower station, which fits the point cloud into a cylinder model in real time by real-time laser scanning inside the water diversion pipeline, acquires the position, speed and attitude of the UAV in real time according to the information of the airborne IMU and the air pressure sensor with the parameters of the cylinder model, calculates the target point of the UAV according to the central axis of the cylinder model, and finally controls the UAV to fully autonomously inspect the inside of the water diversion pipeline according to the above information. The whole process does not need too much manual operation, and the axis direction of the pipeline does not need to rely too much on vision, so the present invention can adapt to pipeline environments with different bending degrees.

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a flow chart of a positioning and navigation method for automatic inspection of an unmanned aerial vehicle in a water diversion pipeline of a hydropower station provided by the present invention;

FIG. 2 shows point clouds scanned by a laser radar provided by the present invention at different parts;

FIG. 3 is a schematic diagram of the fitting process of the central axis of a cylinder model provided by the present invention;

FIG. 4 is a schematic diagram of equidistantly cutting a plane at different parts provided by the present invention;

FIG. 5 shows 50 cut planes of a certain frame provided by the present invention;

FIG. 6 shows an ellipse model in a three-dimensional space provided by the present invention.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

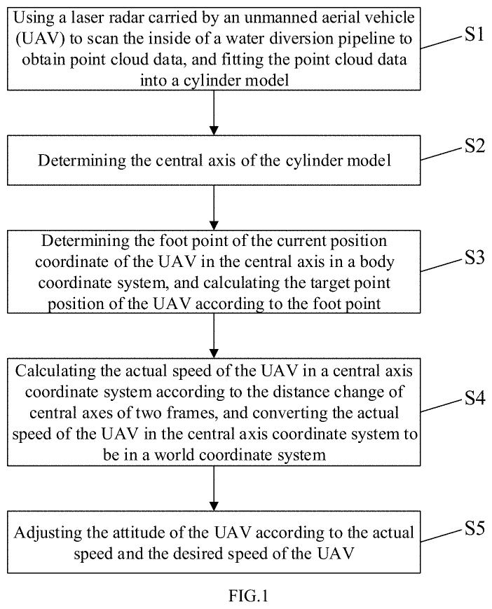

As shown in FIG. 1, embodiments of the present invention disclose a positioning and navigation method for automatic inspection of an unmanned aerial vehicle in a water diversion pipeline of a hydropower station, comprising:

S1. using a laser radar carried by an unmanned aerial vehicle (UAV) to scan the inside of a water diversion pipeline to obtain point cloud data, and fitting the point cloud data into a cylinder model;

S2. determining the central axis of the cylinder model;

S3. determining the foot point of the current position coordinate of the UAV in the central axis in a body coordinate system, and calculating the target point position of the UAV according to the foot point;

S4. calculating the actual speed of the UAV in a central axis coordinate system according to the distance change of central axes of two frames, and converting the actual speed of the UAV in the central axis coordinate system to be in a world coordinate system;

S5. adjusting the attitude of the UAV according to the actual speed and the desired speed of the UAV.

The above steps are further described below.

S1. using a laser radar carried by an unmanned aerial vehicle (UAV) to scan the inside of a water diversion pipeline to obtain point cloud data, and fitting the point cloud data into a cylinder model

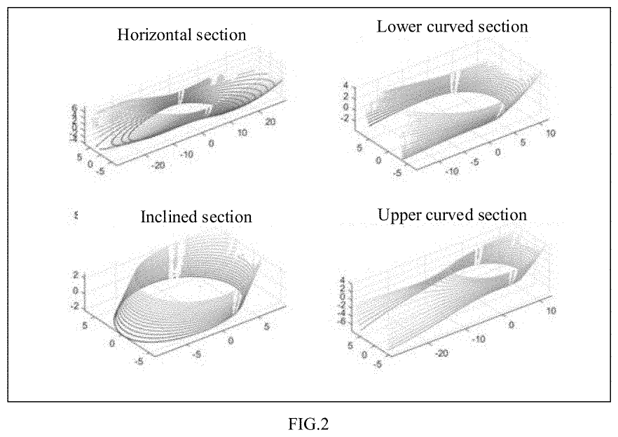

In this step, the point cloud data need processing. In the inspection process of the UAV, the point cloud scanned by the laser radar will inevitably contain noise, as shown in FIG. 2, and the noise can be divided into the following categories according to sources of errors: (1) errors caused by surface factors of a measured object, such as surface roughness, surface waviness and processing accuracy. From the view of pressure pipelines, the main errors come from welding seams of pressure steel pipes and corrosion and dents of the pressure steel pipes, but these errors are small and have little influence on the processing of the point clouds; (2) errors of a measurement system, such as measurement accuracy of a laser radar. From the view of inspection of the laser radar carried by the UAV, the point cloud noise of the laser radar mainly comes from shielding of other devices on the UAV or the body of the UAV to scanning of the laser radar, such shielding directly causes missing of the point cloud, a part of the point cloud is missing in each frame, which is caused by shielding of the UAV tripod to the laser radar, and all the noises need filtering processing; and (3) random errors, which are errors randomly occurring in the measurement process, for example, caused by ambient interference such as equipment placed around or personnel and vibration of the UAV, and such errors are large and need filtering processing.

The step of preprocessing mainly comprises:

1) Determining the center point of the point cloud data, and capturing point cloud data with the distance from each point to the center point more than 1 m and less than 10 m from the point cloud data.

Assuming that the coordinate set of a three-dimensional point cloud space scanned by the laser radar can be expressed as {³=fₚ (xᵢ, yᵢ, zᵢ)∈R³} and any point in the point cloud is pᵢ∈P_{ci}. To reduce the influence of the noise point cloud on subsequent processing, the present invention firstly adopts pass-through filtering to calculate the distance r_{ci}=x_{ci}²+y_{ci}²+z_{ci}², from each point in the point cloud to the center point (0, 0, 0). When r_{ci} of p_i meets 1 m<r_{ci}<10 m, this part of the point cloud is retained, and the rest of the point cloud is discarded.

2) Calculating the average distance and standard deviation from each point to the nearest K points in the captured point cloud data by a statistical filtering method, and eliminating a noise point cloud according to the standard deviation criterion.

After pass-through filtering, conducting statistical filtering on the point cloud, N(p_i), and N(pi) is an index set of k points with Euclidean distance from the point pi, i.e., k neighborhood. K is adjusted according to the number of point clouds. In the embodiments of the present invention, k=20. Assuming that di is the Euclidean distance from the point to the neighborhood point, the average distance of the neighborhoods is:

μ=Σᵢ₌₁^{k}dᵢ/k

The standard deviation is:

σ=\sqrt{(Σᵢ₌₁^{k}dᵢ−μ)²/k}

When pi meets ∥μ−3σ∥≤dᵢ≤∥μ+3σ∥, this part of the point cloud will be retained. If the remaining points do not meet the 3σ criterion, the points are regarded as outliers and eliminated from the point clouds.

At this time, the coordinate set of the point clouds is the coordinate in a laser radar system. For the unified processing of subsequent data, the present invention rotates the point clouds uniformly to the body coordinate system according to the pitch angle θ, the roll angle ϕ and the subsequently calculated yaw angle ψₗₐₛₜ (the initial value is set to 0) of the IMU (Please note that the yaw at this time is the yaw calculated at the point cloud moment of the previous frame) as well as the yaw angle of the point cloud of the current frame between this moment and the previous moment. Thus,

$${P}_{B} = {R}_{L}^{B} {P}_{L} = [ \begin{matrix}cos ψ & - sin ψ & 0 \\ sin ψ & cos ψ & 0 \\ 0 & 0 & 1\end{matrix} ] [ \begin{matrix}cos θ & 0 & sin θ \\ 0 & 1 & 0 \\ - sin θ & 0 & cos θ\end{matrix} ] [ \begin{matrix}1 & 0 & 0 \\ 0 & cos ϕ & - sin ϕ \\ 0 & sin ϕ & cos ϕ\end{matrix} ] {P}_{L}$$

$${P}_{B} = [ \begin{matrix}c ψ c θ & c ψ s θ s ϕ - s ψ c ϕ & c ψ s θ c ϕ + s ψ s ϕ \\ s ψ c θ & s ψ s θ s ϕ + c ψ c ϕ & s ψ s θ c ϕ - c ψ s ϕ \\ - s θ & c θ s ϕ & c θ c ϕ\end{matrix} ] {P}_{L}$$

In the above formula, c represents a cosine function cos, s represents a sine function sin, P_{L} is a coordinate set of three-dimensional point cloud space in the laser radar system, and P_{B} is a three-dimensional point cloud space coordinate of rotated P_{L} in the body coordinate system.

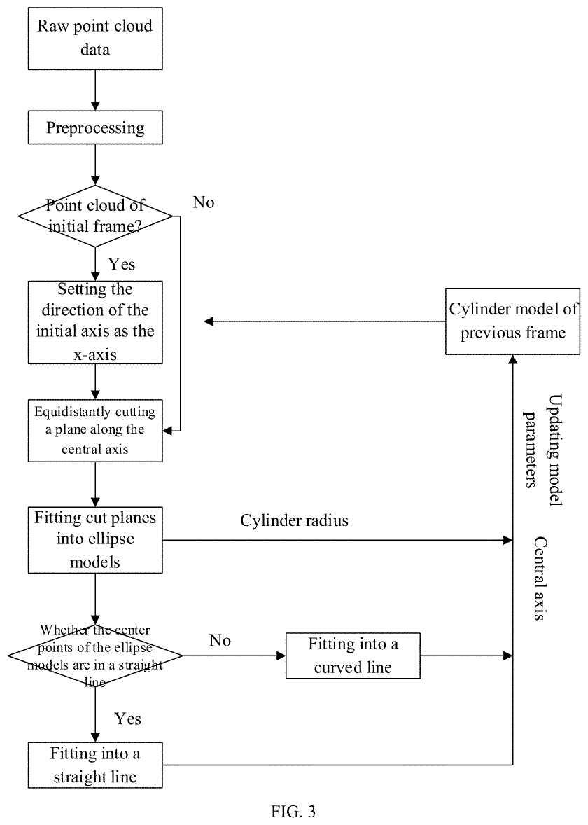

In an embodiment, as shown in FIG. 3, the step of determining the central axis of the cylinder model in S2 comprises:

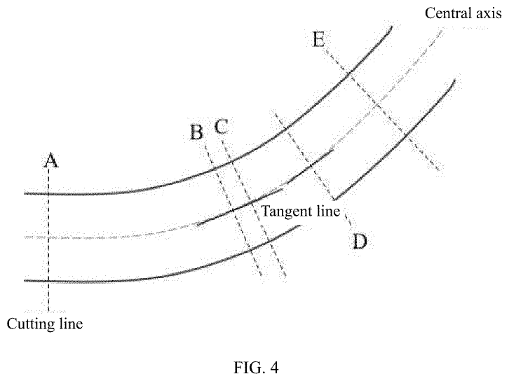

S21. equidistantly cutting the cylinder model of the current frame along the X-axis direction of the world coordinate system to obtain a plurality of cut planes; the layout direction of the water diversion pipeline and the X-axis direction of the laser radar coincide with the X-axis of the world coordinate system; the point cloud of the initial frame is selected to be equidistantly cut along the X-axis; and the point cloud of the non-initial frame is equidistantly cut along the central axis of the cylinder model of the previous frame, wherein the central axis is a curved line at a curved section, the normal direction of the cut plane is the tangent line at the cut point of the curved line, and the cut planes at a horizontal section, a curved section and an inclined section are shown in FIG. 4.

Specifically, as the center line of the cylinder model of the point cloud of the previous frame may be a straight or curved line, when the central axis is a straight line, the point cloud is fitted into a cylinder model as follows:

(x−x′₀)²+(y−y′₀)²+(z−z′₀)²−[a′(x−x′₀)+b′(y−y′₀)+c′(z−z′ₒ)]²=r′₀²

The central axis is:

$$\frac{x - {x}_{0}^{′}}{{a}^{′}} = \frac{y - {y}_{0}^{′}}{{b}^{′}} = \frac{z - {z}_{0}^{′}}{{c}^{′}}$$

When the central axis is a curved line, the UAV performs inspection at a curved section, and the mathematical model of the curved section is complex, so no formula is available for the mathematical model at present. Therefore, in the embodiments of the present invention, a plane is equidistantly cut along the central axis based on the idea of differentiation. When the spacing of the equidistantly cut planes such as cut planes B and C shown in FIG. 4 is small enough, a point cloud between the cut planes B and C can be approximately considered as a cylinder model. Considering that the shape of a cubic curve is fitted to that of an upper curved section and a lower curved section, and comparison tests of the ellipse center point of the tangent plane of the curved section through second-order, third-order and fourth-order polynomial fitting curves show that the third-order polynomial has the best fitting effect with a lower possibility of under-fitting or over-fitting and also has high calculation efficiency, so the present invention finally adopts the cubic polynomial fitting ellipse center curve. The layout of the pressure pipeline of the hydropower station coincides with the X-axis of the world coordinate system, a curved line fitted from the ellipse center point is on the XOZ plane, and the curve equation of the body coordinate system at the previous moment can be expressed as:

$$\{ \begin{matrix}y = 0 \\ z = {w}_{0}^{′} + {w}_{1}^{′} x + {w}_{2}^{′} {x}^{2} + {w}_{3}^{′} {x}^{3}\end{matrix}$$

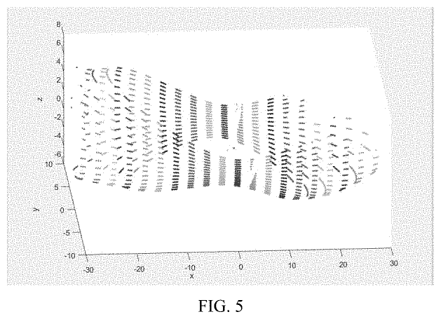

In a specific embodiment, the present invention selects points equidistantly along the X direction of the world coordinate system, and sorts the point clouds of each frame according to the X coordinate, so as to ensure that the point clouds of each frame can have 50 cut planes. FIG. 5 shows 50 cut planes of a certain frame. The method can avoid the problem that an ellipse model cannot be fitted due to the insufficient number of point clouds on the first and last cut planes.

Therefore, the spacing of the cut planes is:

$$step = \frac{{x}_{max} - {x}_{min}}{52}$$

xₘₐₓ represents the maximum value in the x-axis direction in a three-dimensional coordinate set of point clouds, and xₘᵢₙ represents the minimum value in the x-axis direction in a three-dimensional coordinate set of point clouds.

When the center line of the cylinder model of the previous frame is a straight line, the cut point is:

$$\{ \begin{matrix}\begin{matrix}{x}_{i} = {x}_{min} + i \times step \\ {y}_{i} = \frac{{b}^{′} ( {x}_{i} - {x}_{0} )}{{a}^{′}} + {y}_{0}^{′}\end{matrix} \\ {z}_{i} = \frac{{c}^{′} ( {x}_{i} - {x}_{0} )}{{a}^{′}} + {z}_{0}^{′}\end{matrix}$$

Drawing a plane through the cut point and perpendicular to the center line of the previous frame to obtain a cut plane, and the expression of the cut plane is:

a′(x−xᵢ)+b′(y−yᵢ)+c′(z−zᵢ)=0

Wherein (xi, yi, zi) represents a point on the cut plane, which is also a point in the central axis of the cylinder model; i=1, 2 . . . , 49, 50 represents the number of the cut planes of the current frame; x₀ represents the X direction coordinate of a point which the center line of the cylinder model of the previous frame passes; y′₀ represents the Y-direction coordinate of a point which the center line of the cylinder model of the current frame passes; z′₀ represents the Z-direction coordinate of a point which the center line of the cylinder model of the current frame passes; a′ represents the X direction of the direction vector of the center line of the cylinder model of the current frame; b′ represents the Y-direction of the direction vector of the center line of the cylinder model of the current frame; and c′ represents the Z-direction of the direction vector of the center line of the cylinder model of the current frame.

When the center line of the cylinder model of the previous frame is a curved line, the cut point is:

$$\{ \begin{matrix}{x}_{i} = {x}_{min} + i \times step \\ {y}_{i} = 0 \\ {z}_{i} = {w}_{0}^{′} + {w}_{1}^{′} {x}_{i} + {w}_{2}^{′} {x}_{i}^{2} + {w}_{3}^{′} {x}_{i}^{3}\end{matrix}$$

Drawing a tangent line through the cut point, and the expression of the tangent line is:

$$\{ \begin{matrix}y = 0 \\ z = ( {w}_{1} + 2 {w}_{2} {x}_{i c} + 3 {w}_{3} {x}_{i c}^{2} ) ( x - {x}_{i c} ) + {z}_{ic}\end{matrix}$$

Drawing a plane through the cut point and perpendicular to the tangent line to obtain a cut plane, and the expression of the cut plane is:

x−x_{ic}+(w₁+2w₂x_{ic}+3w₃x_{ic}²)(z−z_{ic})=0

Wherein w′₀ represents the constant term of the curvilinear polynomial of the center line of the cylinder model of the previous frame, w′₁ represents the primary term of the curvilinear polynomial of the center line of the cylinder model of the previous frame, w′₂ represents the quadratic term of the curvilinear polynomial of the center line of the cylinder model of the previous frame, and the w′₃ represents the cubic term of the curvilinear polynomial of the center line of the cylinder model of the previous frame; w₁ represents the primary term of the curvilinear polynomial of the center line of the cylinder model of the current frame, w₂ represents the quadratic term of the curvilinear polynomial of the center line of the cylinder model of the current frame, and the w₃ represents the cubic term of the curvilinear polynomial of the center line of the cylinder model of the current frame; x_{ic} represents the X direction coordinate of a point which the i^{th} cut plane passes; and z_{ic} represents the Z-direction coordinate of a point which the i^{th} cut plane passes.

Since the curve equation is the central axis of the point cloud of the previous frame at this moment, the current point cloud is cut along the central axis of the previous moment, and the cut plane may be a circle or ellipse.

S22. fitting a point cloud on each cut plane into an ellipse model based on the RANSAC algorithm; comprising:

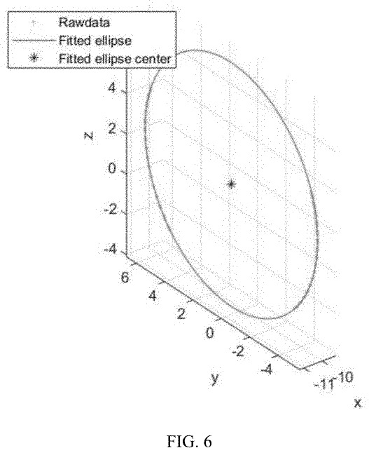

S221. respectively fitting the point cloud on each cut plane under the current frame into an ellipse model by the nonlinear least square method and the RANSAC algorithm, as shown in FIG. 6.

The present invention derives an ellipse model according to the definition of an ellipse. An ellipse is the trajectory of a point P whose sum of distances to two different fixed points (F1,F2) is a constant on the plane, and the mathematical expression is:

|PF₁+|+|PF₂|=2a(2a>|F₁F₂|)

S222. calculating the center point and the minor semi-axis of each ellipse model.

An ellipse model in a three-dimensional space can be determined by the following parameters:

1) Two focal points F₁(x₁, y₁, z₁), F₂ (x₂, y₂, z₂);

2) Ellipse major semi-axis a;

Then, the following relation holds:

$$\{ \begin{matrix}\begin{matrix}\begin{matrix}\sqrt{{( x - {x}_{1} )}^{2} + {( y - {y}_{1} )}^{2} + {( z - {z}_{1} )}^{2}} + \\ \sqrt{{( x - {x}_{2} )}^{2} + {( y - {y}_{2} )}^{2} + {( z - {z}_{2} )}^{2}} = 2 a\end{matrix} \\ {c}^{2} = {( {x}_{1} - {x}_{2} )}^{2} + {( {y}_{1} - {y}_{2} )}^{2} + {( {z}_{1} - {z}_{2} )}^{2}\end{matrix} \\ {b}^{2} = {a}^{2} - {c}^{2}\end{matrix}$$

Wherein a is the major semi-axis, h is the minor semi-axis, c is the distance between the two focal points, and the ellipse center point is

$$C ( \frac{{x}_{1} + {x}_{2}}{2} , \frac{{y}_{1} + {y}_{2}}{2} , \frac{{z}_{1} + {z}_{2}}{2} ) .$$

S223. averaging the minor semi-axes of all the ellipse models, and taking the obtained average value as the radius of the cylinder model of the current frame.

Calculating the ellipse center point cluster {Cᵢ=x_{ci}, y_{ci}, z_{ci}} and the ellipse minor semi-axis bᵢ of each cut plane. The average value of the ellipse semi-minor axes is b̅=Σᵢ₌₁ⁿ bᵢ/n, and b̅ is the radius r of the cylinder model of the current frame.

S23. fitting an ellipse center point cluster under the current frame into a straight or curved line to be used as the central axis of the cylinder model of the current frame.

If the central axis of the cylinder model of the previous frame is a straight line, fitting each ellipse center point into a linear model by the RANSAC algorithm, and if the number of interior points that fit the linear model is more than a half, considering the central axis of the current frame as a straight line, or fitting the ellipse center point cluster into a curved line;

If the central axis of the cylinder model of the previous frame is a curved line, fitting all the ellipse center points under the current frame into a curved line; and when coefficients of the second order and above of the polynomial describing the curved line are less than 0.01, refitting the ellipse center point cluster into a straight line.

It is difficult to solve a curve in a three-dimensional space, the water diversion pipeline has uniaxial axisymmetric structure, and the symmetry axis is on the XOZ plane of the world coordinate system of the present invention, so the present invention fits the ellipse of the space plane where the ellipse center point is located in the body coordinate system by the RANSAC algorithm before fitting a straight or curved line, thus obtaining a space ellipse model.

The process of fitting the ellipse model by the RANSAC algorithm is:

\textcircled{1}. Randomly selecting sample points from the ellipse center points, wherein the number of the sample points is more than 4;

\textcircled{2}. Calculating the parameter of each cut plane model under the current frame for the selected sample points by the least square model fitting method;

\textcircled{3}. Calculating fitting residuals between all the sample points and the parameters of the cut planes obtained in \textcircled{2};

\textcircled{4}. If the number of the samples recorded in \textcircled{3} is more than the threshold of the number of the interior points, stopping searching for interior points and saving the sample data;

\textcircled{5}. Repeating \textcircled{2} to \textcircled{4} for N times, and if the number of the interior points is less than the threshold of the number of the interior points, stopping searching for interior points, and saving the maximum number of interior points in the interior point set and sample data;

\textcircled{6}. Solving the parameter of the ellipse model for the sample data saved in \textcircled{4} or \textcircled{5} by least square fitting, and the obtained parameter is the optimum parameter for fitting of the ellipse model.

Wherein the principle of the least square space fitting method is as follows:

The reduced form of a space straight line is:

$$\frac{x - {x}_{0}}{{a}_{l}} = \frac{y - {y}_{0}}{{b}_{l}} = \frac{z}{1}$$

The equation can be reduced as:

$$\{ \begin{matrix}x = {x}_{0} + {a}_{l} z \\ y = {y}_{0} + {b}_{l} z\end{matrix}$$

The matrix form of the linear equation of the i^{th} point in the ellipse center point cluster is:

$$[ \begin{matrix}{a}_{l} & {x}_{0} \\ {b}_{l} & {y}_{0}\end{matrix} ] [ \begin{matrix}{z}_{c i} \\ 1\end{matrix} ] = [ \begin{matrix}{x}_{c i} \\ {y}_{c i}\end{matrix} ]$$

x_{ci}, y_{ci} and z_{ci} represent the coordinate of the ellipse center point of the i^{th} cut plane respectively;

Least square fitting is performed on n ellipse center points:

$$[ \begin{matrix}{a}_{l} & {x}_{0} \\ {b}_{l} & {y}_{0}\end{matrix} ] = {[ \begin{matrix}\sum {x}_{ci} {z}_{ci} & \sum {x}_{ci} \\ \sum {y}_{ci} {z}_{ci} & \sum {z}_{ci}\end{matrix} ] [ \begin{matrix}\sum {z}_{ci}^{2} & \sum {z}_{ci} \\ \sum {z}_{ci} & n\end{matrix} ]}^{- 1}$$

The parameter of the space linear model is calculated according to the above least square method.

The equation of the space plane can be expressed as:

Ax+By+Cz+1=0

n ellipse center points are fitted into a plane, and the matrix form is as follows:

$$[ \begin{matrix}{x}_{1} & {y}_{1} & {z}_{1} \\ ⋮ & ⋮ & ⋮ \\ {x}_{n} & {y}_{n} & {z}_{n}\end{matrix} ] [ \begin{matrix}A \\ B \\ C\end{matrix} ] = [ \begin{matrix}- 1 \\ - 1 \\ - 1\end{matrix} ]$$

Then the parameter of a space plane model is solved by least square fitting:

$$[ \begin{matrix}A \\ B \\ C\end{matrix} ] = [ \begin{matrix}Σ {x}_{c i}^{2} & Σ {x}_{c i} {y}_{c i} & Σ {x}_{c i} {z}_{c i} \\ Σ {x}_{c i} {y}_{c i} & Σ {y}_{c i}^{2} & Σ {y}_{ci} {z}_{ci} \\ Σ {x}_{c i} {z}_{c i} & Σ {y}_{ci} {z}_{ci} & Σ {z}_{c i}^{2}\end{matrix} ] [ \begin{matrix}- Σ {x}_{c i} \\ - Σ {y}_{c i} \\ - Σ {z}_{c i}\end{matrix} ]$$

In the body coordinate system, a plane β of this curved line is parallel to the XOZ plane of the world coordinate system, the normal vector of the XOZ plane of the body coordinate system is (0, 1, 0), the normal vector of the plane β is (A, B, C), and the included angle γ between the two planes is:

$$γ = arcos \frac{B}{\sqrt{{A}^{2} + {B}^{2} + {C}^{2}}}$$

The included angle is the course deviation angle of the current moment relative to the previous moment, the yaw angle at the current moment is ψ_{cur}=ψₗₐₛₜ+γ, and then the ellipse center point cluster of each cut plane is projected to the XOZ plane of the body coordinate system at the current moment:

$${C}_{i}^{′} = [ \begin{matrix}cos γ & - s in γ & 0 \\ sin γ & cos γ & 0 \\ 0 & 0 & 1\end{matrix} ] {C}_{i}$$

At this moment, the curved line can be fitted by a polynomial:

$$z ( x , W ) = {w}_{0} + {w}_{1} x + {w}_{2} {x}^{2} + … + {w}_{m} {x}^{m} \\ Letting W = [ \begin{matrix}{w}_{0} \\ {w}_{1} \\ ⋮ \\ {w}_{m}\end{matrix} ] , X = [ \begin{matrix}1 & {x}_{1} & … & {x}_{1}^{m} \\ 1 & {x}_{2} & … & {x}_{2}^{m} \\ ⋮ & ⋮ & ⋱ & ⋮ \\ 1 & {x}_{n} & … & {x}_{n}^{m}\end{matrix} ]$$

The polynomial function can be reduced to a linear algebraic form:

z(x,W)=XW

X represents (x₁, x₂, . . . , xₙ); and W represents (w₁, w₂, . . . , wₙ).

An objective function is established to calculate the square error between the target value and the predicted value of a sample point. To avoid over-fitting, the present invention introduces a regular term to balance the influence caused by higher-order polynomials, and the objective loss function is as follows:

$$E ( w ) = \frac{1}{2} {\sum }_{n = 1}^{N} {( z ( {x}_{n} , W ) - {t}_{n} )}^{2} + \frac{λ}{2} {‖ w ‖}^{2} = \frac{1}{2} {( XW - T )}^{T} ( XW - T ) + \frac{λ}{2} {‖ w ‖}^{2}$$

Wherein z(xₙ, W) represents the linear algebraic expression of the above polynomial function; tₙ represents the target value of the n^{th} sample; N represents the total number of samples; λ represents a regularization parameter; T represents (t₁, t₂, . . . , tₙ); and ∥w∥²=w^{T}w=w₀²+w₁²+ . . . +wₘ²,

$$\frac{\partial E ( w )}{\partial w} = \frac{1}{m + 1} ( ( {X}^{T} X + λ {E}_{m + 1} ) W - {X}^{T} T ) = 0 \\ W = {( {X}^{T} X + λ {E}_{m + 1} )}^{- 1} {X}^{T} T$$

Then the parameter of the polynomial curve can be determined.

In a specific embodiment, to realize the comprehensive inspection of a water diversion pipeline of a hydropower station by a multi-rotor UAV, the UAV moves along the center line of the water diversion pipeline. In the local body coordinate system of each frame, the difference between the desired position and the current position is obtained and adjusted through PID proportional integral, and the desired speed is convened; and the desired attitude and throttle are obtained by estimation according to the desired speed and the current speed, the information is transmitted to the underlying flight control, and the rotation of the motor is controlled by the underlying flight control, so as to control the movement of the UAV.

How to calculate the target point of the UAV and estimate the speed of the UAV according to the central axis of the cylinder model and sensors such as IMU and barometer will be described below in detail.

If the central axis is a curved line, the coordinate of the UAV in the body coordinate system is (0, 0, 0), the closest point D (x_{d}, y_{d}, z_{d}) of the UAV to the central axis and the tangent line at this point can be calculated according to the curve equation, and the tangent line at this point is taken as the central axis of an approximate cylinder model. When the central axis is a straight line, the cylinder model is:

$${( x - {x}_{i} )}^{2} + {( y - {y}_{i} )}^{2} + {( z - {z}_{i} )}^{2} - {r}_{i}^{2} = \frac{{[ {a}_{i} ( x - {x}_{i} ) + {b}_{i} ( y - {y}_{i} ) + {c}_{i} ( z - {z}_{i} ) ]}^{2}}{{a}_{i}^{2} + {b}_{i}^{2} + {c}_{i}^{2}}$$

$$\frac{x - {x}_{i}}{{a}_{i}} = \frac{y - {y}_{i}}{{b}_{i}} = \frac{z - {z}_{i}}{{c}_{i}}$$

The coordinate of the UAV in the body coordinate system of the i^{th} frame is (0,0,0), the foot point of this point in the center line is D (x_{d}, y_{d}, z_{d})==(xᵢ+uᵢaᵢ, yᵢ+uᵢbᵢ, zᵢ+uᵢcᵢ), and the target point is T(xₜ, yₜ, zₜ)=(x_{d}+kaₜ, y_{d}+kbᵢ, z_{d}+kcᵢ). δ is the included angle between the central axis and the XOY plane of the body coordinate system. In the body coordinate system, the direction of the Z-axis is (0, 0, 1), the direction vector of the central axis is (aᵢ, bᵢ, cᵢ), and the included angle is calculated according to the direction vector:

$$sin {δ}_{i} = \frac{( {a}_{i} , {b}_{i} , {c}_{i} ) \cdot ( 0 , 0 , 1 )}{\vert {a}_{i} , {b}_{i} , {c}_{i} \vert \vert 0 , 0 , 1 \vert} ⇒ {δ}_{i} = sec {c}_{i}$$

According to the above formula, the distance from the UAV to the central axis and the component in the YZ direction in the body coordinate system can be calculated, and the expression of the Z direction vector of the central axis coordinate system in the body coordinate system can be obtained according to the cross product of the X direction vector (aᵢ, bᵢ, cᵢ) and the Y direction vector (sin γᵢ, cos γᵢ, 0) of the central axis coordinate system:

Z(z1,z2,z3)=(aᵢ,bᵢ,cᵢ)×(sin γᵢ,cos γᵢ,0)=(—cᵢ cos γᵢ,cᵢ sin γᵢ,aᵢ cos γᵢ−bᵢ sin γᵢ)

The distance from the UAV to the foot point is projected to the Y direction and Z direction of the central axis coordinate system respectively:

$$\{ \begin{matrix}D i {s}_{y} = ( {x}_{i} + {u}_{i} {a}_{i} , {y}_{i} + {u}_{i} {b}_{i} , {z}_{i} + {u}_{i} {c}_{i} ) \cdot ( sin {γ}_{i} , cos {γ}_{i} , 0 ) \\ D i {s}_{z} = ( {x}_{i} + {u}_{i} {a}_{i} , {y}_{i} + {u}_{i} {b}_{i} , {z}_{i} + {u}_{i} {c}_{i} ) \cdot ( z 1 , z 2 , z 3 )\end{matrix}$$

Speeds V_{cy}, V_{cz} of the UAV in the central axis coordinate system can be calculated according to the distance change of two frames, and V_{cy}=V_{wy}. In the inclined section, the Z-direction speed V_{wz} in the world coordinate system is calculated by combination of a barometer and an accelerometer, and the Z-direction speed V_{cz} in the central axis coordinate system is obtained through the above formula. According to the rotation relationship of the coordinate systems, the following relation is established, and the speed in the central axis coordinate system is converted to be in the world coordinate system.

$$[ \begin{matrix}{V}_{w x} \\ {V}_{w z}\end{matrix} ] = [ \begin{matrix}cos δ & - s in δ \\ sin δ & cos δ\end{matrix} ] [ \begin{matrix}{V}_{c x} \\ {V}_{c z}\end{matrix} ]$$

In the above formula, V_{cx}, V_{cz} represent the speed of the UAV in the central axis coordinate system, V_{wx}, V_{wz} represent the speed of the UAV in the world coordinate system, and V_{wx} can be solved as follows according to the above formula:

$${V}_{w x} = \frac{( {V}_{w z} - {V}_{c z} cos δ )}{sin δcos δ} - {V}_{c z} sin δ .$$

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A positioning and navigation method for automatic inspection of an unmanned aerial vehicle in a water diversion pipeline of a hydropower station, comprising:
using a laser radar carried by an unmanned aerial vehicle (UAV) to scan the inside of a water diversion pipeline to obtain point cloud data, and fitting the point cloud data into a cylinder model;
determining the central axis of the cylinder model;
determining the foot point of the current position coordinate of the UAV in the central axis in a body coordinate system, and calculating the target point position of the UAV according to the foot point;
calculating the actual speed of the UAV in a central axis coordinate system according to the distance change of central axes of two frames, and converting the actual speed of the UAV in the central axis coordinate system to be in a world coordinate system;
adjusting the attitude of the UAV according to the actual speed and the desired speed of the UAV.

2. The positioning and navigation method for automatic inspection of an unmanned aerial vehicle in a water diversion pipeline of a hydropower station according to claim 1, further comprising:
preprocessing the point cloud data, wherein the step of preprocessing comprises:
determining the center point of the point cloud data, and capturing point cloud data with the distance from each point to the center point more than 1 m and less than 10 m from the point cloud data;
calculating the average distance and standard deviation from each point to the nearest K points in the captured point cloud data by a statistical filtering method, and eliminating a noise point cloud according to the standard deviation criterion.

3. The positioning and navigation method for automatic inspection of an unmanned aerial vehicle in a water diversion pipeline of a hydropower station according to claim 1, wherein the step of determining the central axis of the cylinder model comprises:
equidistantly cutting the cylinder model of the current frame along the X-axis direction of the world coordinate system to obtain a plurality of cut planes; and the layout direction of the water diversion pipeline coincides with the X-axis of the world coordinate system;
fitting a point cloud on each cut plane into an ellipse model based on the RANSAC algorithm;
fitting an ellipse center point cluster under the current frame into a straight or curved line to be used as the central axis of the cylinder model of the current frame.

4. The positioning and navigation method for automatic inspection of an unmanned aerial vehicle in a water diversion pipeline of a hydropower station according to claim 3, wherein when the center line of the cylinder model of the previous frame is a straight line, the cut point is:
$$\{ \begin{matrix}{x}_{i} = {x}_{min} + i ⨯ step \\ {y}_{i} = \frac{{b}^{′} ( {x}_{i} - {x}_{0} )}{{a}^{′}} + {y}_{0}^{′} \\ {z}_{i} = \frac{{c}^{′} ( {x}_{i} - {x}_{0} )}{{a}^{′}} + {z}_{0}^{′}\end{matrix}$$
drawing a plane through the cut point and perpendicular to the center line of the previous frame to obtain a cut plane, and the expression of the cut plane is:
a′(x−xᵢ)+b′(y−yᵢ)+c′(z−zᵢ)=0
wherein (xi, yi, zi) represents a point on the cut plane, which is also a point in the central axis of the cylinder model;
$$step = \frac{{x}_{max} - {x}_{min}}{52}$$
represents the spacing of cut planes, xₘₐₓ represents the maximum value in the x direction in a three-dimensional coordinate set of point clouds, and xₘᵢₙ represents the minimum value in the x direction in the three-dimensional coordinate set of point clouds; i represents the number of the cut planes of the current frame; x₀ represents the X direction coordinate of a point which the center line of the cylinder model of the previous frame passes; y′₀ represents the Y-direction coordinate of a point which the center line of the cylinder model of the current frame passes; z′₀, represents the Z-direction coordinate of a point which the center line of the cylinder model of the current frame passes; a′ represents the X direction of the direction vector of the center line of the cylinder model of the current frame; b′ represents the Y-direction of the direction vector of the center line of the cylinder model of the current frame; and c′ represents the Z-direction of the direction vector of the center line of the cylinder model of the current frame.

5. The positioning and navigation method for automatic inspection of an unmanned aerial vehicle in a water diversion pipeline of a hydropower station according to claim 3, wherein when the center line of the cylinder model of the previous frame is a curved line, the cut point is:
$$\{ \begin{matrix}{x}_{i} = {x}_{min} + i ⨯ step \\ {y}_{i} = 0 \\ {z}_{i} = {w}_{0}^{′} + {w}_{1}^{′} {x}_{i} + {w}_{2}^{′} {x}_{i}^{2} + {w}_{3}^{′} {x}_{i}^{3}\end{matrix}$$
drawing a tangent line through the cut point, and the expression of the tangent line is:
$$\{ \begin{matrix}y = 0 \\ z = ( {w}_{1} + 2 {w}_{2} {x}_{i c} + 3 {w}_{3} {x}_{i c}^{2} ) ( x - {x}_{i c} ) + {z}_{i c}\end{matrix}$$
drawing a plane through the cut point and perpendicular to the tangent line to obtain a cut plane, and the expression of the cut plane is:
x−x_{ic}+(w₁+2w₂x_{ic}+3w₃x_{ic}²(z−z_{ic})=0
wherein w′₀ represents the constant term of the curvilinear polynomial of the center line of the cylinder model of the previous frame, w′₁ represents the primary term of the curvilinear polynomial of the center line of the cylinder model of the previous frame, w′₂ represents the quadratic term of the curvilinear polynomial of the center line of the cylinder model of the previous frame, and the w′₃ represents the cubic term of the curvilinear polynomial of the center line of the cylinder model of the previous frame; w₁ represents the primary term of the curvilinear polynomial of the center line of the cylinder model of the current frame, w₂ represents the quadratic term of the curvilinear polynomial of the center line of the cylinder model of the current frame, and the w₃ represents the cubic term of the curvilinear polynomial of the center line of the cylinder model of the current frame; x_{ic} represents the X direction coordinate of a point which the i^{th} cut plane passes; and z_{ic} represents the Z-direction coordinate of a point which the i^{th} cut plane passes.

6. The positioning and navigation method for automatic inspection of an unmanned aerial vehicle in a water diversion pipeline of a hydropower station according to claim 3, wherein the step of fitting a point cloud on each cut plane into an ellipse model based on the RANSAC algorithm comprises:
respectively fitting the point cloud on each cut plane under the current frame into an ellipse model by the nonlinear least square method and the RANSAC algorithm;
calculating the center point and the minor semi-axis of each ellipse model;
averaging the minor semi-axes of all the ellipse models, and taking the obtained average value as the radius of the cylinder model of the current frame.

7. The positioning and navigation method for automatic inspection of an unmanned aerial vehicle in a water diversion pipeline of a hydropower station according to claim 3, wherein the step of fitting an ellipse center point cluster under the current frame into a straight or curved line comprises:
if the central axis of the cylinder model of the previous frame is a straight line, fitting each ellipse center point into a linear model by the RANSAC algorithm, and if the number of interior points that fit the linear model is more than a half, considering the central axis of the current frame as a straight line, or fitting the ellipse center point cluster into a curved line;
if the central axis of the cylinder model of the previous frame is a curved line, fitting all the ellipse center points under the current frame into a curved line; and when coefficients of the second order and above of the polynomial describing the curved line are less than 0.01, refitting the ellipse center point cluster into a straight line.

8. The positioning and navigation method for automatic inspection of an unmanned aerial vehicle in a water diversion pipeline of a hydropower station according to claim 7, wherein the fitting process of the ellipse model is:
S1. randomly selecting sample points from the ellipse center points, wherein the number of the sample points is more than 4;
S2. calculating the parameter of each cut plane under the current frame for the selected sample points by the least square model fitting method;
S3. calculating fitting residuals between all the sample points and the parameters of the cut planes obtained in □;
S4. if the number of the samples recorded in □ is more than the threshold of the number of the interior points, stopping searching for interior points and saving the sample data;
S5. repeating □ to □ for N times, and if the number of the interior points is less than the threshold of the number of the interior points, stopping searching for interior points, and saving the maximum number of interior points in the interior point set and sample data;
S6. solving the parameter of the ellipse model for the sample data saved in □ or □ by least square fitting, and the obtained parameter is the optimum parameter for fitting of the ellipse model.

9. The positioning and navigation method for automatic inspection of an unmanned aerial vehicle in a water diversion pipeline of a hydropower station according to claim 3, wherein the desired speed of the UAV is determined according to the current position and the target position of the UAV; and the coordinate of the foot point of the current position coordinate of the UAV in the central axis in the body coordinate system is D(x_{d}, y_{d}, z_{d})=(xᵢ+uᵢaᵢ, yᵢ+uᵢbᵢ, zᵢ+uᵢcᵢ);
the coordinate of the target point position is T(xₜ, yₜ, zₜ)=(x_{d}+kaᵢ, y_{d}+kbᵢ, z_{d}+kcᵢ); wherein (aᵢ, bᵢ, cᵢ) is the X-axis direction vector in the central axis coordinate system.

10. The positioning and navigation method for automatic inspection of an unmanned aerial vehicle in a water diversion pipeline of a hydropower station according to claim 9, wherein the calculation process of the actual speed of the UAV in the world coordinate system is:
obtaining the expression of the Z-axis direction vector in the central axis coordinate system in the body coordinate system according to the cross product of the X-axis direction vector and the Y-axis direction vector in the central axis coordinate system:
Z(z1,z2,z3)=(aᵢ,bᵢ,cᵢ)×(sin γᵢ,cos γᵢ,0)=(−cᵢ cos γᵢ,cᵢ sin γᵢ,aᵢ cos γᵢ−bᵢ sin γᵢ)
wherein yᵢ represents an included angle between the plane of the straight or curved line fitted from the ellipse center point cluster of the i^{th} frame and the XOZ plane of the body coordinate system; and (sin γᵢ, cos γᵢ, 0) represents the Y-axis direction vector in the central axis coordinate system;
projecting the distance from the current position of the UAV to the foot point to the Z-axis direction in the central axis coordinate system;
Dis_{z}=(xᵢ+uᵢaᵢ,yᵢ+uᵢbᵢ,zᵢ+uᵢcᵢ)·(z1,z2,z3)
calculating the speed V_{cz} of the UAV in the Z-axis direction in the central axis coordinate system according to the distance change of two frames;
calculating the speed V_{wz} of the UAV in the Z-axis direction in the world coordinate system by combination of a barometer and an accelerometer;
converting the speed in the central axis coordinate system to be in the world coordinate system according to the rotation relationship of the coordinate systems; and the calculation formula of the speed of the UAV in the X-axis direction in the world coordinate system is:
$${V}_{w x} = \frac{( {V}_{w z} - {V}_{c z} cos δ )}{sin δcos δ} - {V}_{c z} sin δ$$
wherein δᵢ=sec cᵢ represents an included angle between the central axis of the i^{th} frame and the XOY plane in the body coordinate system.
